(19) United States
(12) Patent Application Publication
(10) Pub. No.: US 2026/0067002 A1
(43) Pub. Date: Mar. 5, 2026

(54) REDUCING ADVERSE EFFECTS OF ELECTROMAGNETIC INTERFERENCE IN A VEHICLE

(71) Applicant: Infineon Technologies Americas Corp., El Segundo, CA (US)

(72) Inventors: Shaowu HUANG, Los Altos, CA (US); Dance WU, Palo Alto, CA (US)

(21) Appl. No.: 19/319,603

(22) Filed: Sep. 4, 2025

Related U.S. Application Data
(60) Provisional application No. 63/690,776, filed on Sep. 4, 2024.

(51) Int. Cl. H04B 15/02

(52) U.S. Cl. CPC H04B 15/02

(57) ABSTRACT

A communication system in a vehicle includes a first communication device having a first ground, and a second communication device having a second ground. A shielded cable communicatively connects the first communication device and the second communication device. The shielded cable includes i) a signal wire that is electrically connected to the first communication device and the second communication device, and ii) a shield that is electrically coupled to the first ground and the second ground. A first wire electrically connects the first ground to a chassis of the vehicle at a first point. A second wire electrically connects the second ground to the chassis proximate to the first point to mitigate effects of electromagnetic interference (EMI) on the communication system.

### CROSS REFERENCES TO RELATED APPLICATIONS

This application claims the benefit of U.S. Provisional Patent App. No. 63/690,776, entitled “System Architectures of Automotive Ethernet over Coax Cable Channels,” filed on Sep. 4, 2024, the disclosure of which is expressly incorporated herein by reference in its entirety for all purposes.

### FIELD OF TECHNOLOGY

The present disclosure relates generally to in-vehicle communication networks, and more particularly to reducing adverse effects of electromagnetic interference in a vehicle.

### BACKGROUND

In-vehicle communication networks permit components within a vehicle to exchange data. For example, Controller Area Network (CAN) is a communication standard that is widely used in the automotive industry. Additionally, automotive Ethernet is a type of Ethernet network adapted to the automotive environment, which enables high-speed data transfer within vehicles. Automotive Ethernet provides a significantly higher transmission rate as compared to CAN, which allows, among other things, the replacement of multiple CAN cables with a single Ethernet link. As a result, automotive Ethernet reduces the weight of wiring harnesses in vehicles while providing higher bandwidth data transmission compared to CAN. Because of the advantages of automotive Ethernet over CAN and because of the increasing adoption of advanced automotive technologies that require higher data rates, the use of automotive Ethernet in the automotive industry is significantly increasing.

Some automotive Ethernet applications use unshielded twisted pair (UTP) cables. In-band radiated emission (RE), however, is a drawback with using UTP cables in automotive Ethernet. For instance, unshielded cables like UTP cables are inherently very effective antennas. Additionally, some applications, such as applications with relatively high data rates and/or relatively long cable runs, may be especially susceptible to performance degradation due to in-band RE and/or noise with UTP cables.

A coaxial cable includes a central conductor surrounded by a ground shield. As a result of the ground shield, coaxial cables tend to be less susceptible to in-band RE and noise as compared to UTPs. Coaxial cables are used in some in-vehicle communication applications, but communication systems using coaxial cables can be susceptible to ground loop problems.

A ground loop occurs when two ground points of an electrical circuit that are intended to have a same ground reference potential instead have different potentials. This may be caused, for example, when enough current is flowing between the two ground points to cause a voltage drop between the two ground points. The current in a ground loop may be caused by electromagnetic induction, for example, which in turn may be caused by electromagnetic interference (EMI).

A ground loop may result when interconnected electrical components have multiple paths to ground that form a closed conductive loop through the multiple paths. For example, if two communication devices, each connected to a ground chassis by respective ground connections, are interconnected by a coaxial cable and the shield of the coaxial cable is connected to the ground at both communication devices, a closed conductive loop may be formed through the shield of the coaxial cable and the different ground connections to the ground chassis.

Ground loops tend to cause performance degradation. For example, with in-vehicle communication systems, ground loops can cause increased bit error rates.

### SUMMARY

In an embodiment, a communication system for use in a vehicle comprises: a first communication device configured for operation in the vehicle, the first communication device having a first ground; a second communication device configured for operation in the vehicle, the second communication device having a second ground; a shielded cable that communicatively connects the first communication device and the second communication device, the shielded cable having i) a signal wire that is electrically connected to the first communication device and the second communication device, and ii) a shield that is electrically coupled to the first ground and the second ground; a first wire having i) a first end electrically connected to the first ground and ii) a second end electrically connected to a chassis of the vehicle at a first point; and a second wire having i) a first end electrically connected to the second ground and ii) a second end electrically connected to the chassis proximate to the first point to mitigate effects of electromagnetic interference (EMI) on the communication system.

In another embodiment, a method for manufacturing a vehicle includes: installing a first communication device in a chassis of the vehicle, the first communication device having a first ground; installing a second communication device in the chassis, the second communication device having a second ground; connecting a first end of a shielded cable to the first communication device, the first communication device being configured to electrically couple a shield of the shielded cable to the first ground when the shielded cable is connected to the first communication device; connecting a second end of the shielded cable to the second communication device, the second communication device being configured to electrically couple the shield of the shielded cable to the second ground when the shielded cable is connected to the second communication device; electrically connecting a first end of a first wire to the first ground of the first communication device; electrically connecting a second end of the first wire to the chassis at a first point; electrically connecting a first end of a second wire to the second ground of the second communication device; and electrically connecting a second end of the second wire to the chassis proximate to the first point to mitigate effects of electromagnetic interference (EMI) on the communication system.

In yet another embodiment, a communication system for use in a vehicle comprises: a first communication device configured for operation in the vehicle, the first communication device having a first ground; a second communication device configured for operation in the vehicle, the second communication device having a second ground; a shielded cable that communicatively connects the first communication device and the second communication device, the shielded cable having i) a signal wire that is electrically connected to the first communication device and the second communication device, and ii) a shield that is electrically coupled to the first ground and the second ground, wherein the first communication device is configured to couple the shield of the cable to the first ground via one or more first capacitors to mitigate effects of electromagnetic interference (EMI) on the communication system; a first wire having i) a first end electrically connected to the first ground and ii) a second end electrically connected to a chassis of the vehicle at a first point; and a second wire having i) a first end electrically connected to the second ground and ii) a second end electrically connected to the chassis proximate a second point different than the first point.

In still another embodiment, a method for manufacturing a vehicle includes: installing a first communication device in a chassis of the vehicle, the first communication device having a first ground; installing a second communication device in the chassis, the second communication device having a second ground; connecting a first end of a shielded cable to the first communication device, the first communication device being configured to electrically couple a shield of the shielded cable to the first ground via one or more capacitors when the shielded cable is connected to the first communication device to mitigate effects of electromagnetic interference (EMI) on the communication system; connecting a second end of the shielded cable to the second communication device, the second communication device being configured to electrically couple the shield of the shielded cable to the second ground when the shielded cable is connected to the second communication device; electrically connecting a first end of a first wire to the first ground of the first communication device; electrically connecting a second end of the first wire to the chassis at a first point; electrically connecting a first end of a second wire to the second ground of the second communication device; and electrically connecting a second end of the second wire to the chassis at a second point that is different than the first point.

### BRIEF DESCRIPTION OF THE DRAWINGS

FIG. 1 is a simplified diagram of an example vehicle in which various aspects, features, and elements described herein are implemented in accordance with an embodiment of this disclosure.

FIG. 2 is a simplified diagram of an example communication system for use in a vehicle such as the vehicle of FIG. 1, according to an embodiment.

FIG. 3 is a simplified diagram of another example communication system for use in a vehicle such as the vehicle of FIG. 1, according to another embodiment.

FIG. 4 is a simplified diagram of another example communication system for use in a vehicle such as the vehicle of FIG. 1, according to another embodiment.

FIG. 5 is a simplified diagram of another example communication system for use in a vehicle such as the vehicle of FIG. 1, according to another embodiment.

FIG. 6 is a simplified diagram of another example communication system for use in a vehicle such as the vehicle of FIG. 1, according to another embodiment.

FIG. 7 is a simplified diagram of another example communication system for use in a vehicle such as the vehicle of FIG. 1, according to another embodiment.

FIG. 8 is a simplified diagram of another example communication system for use in a vehicle such as the vehicle of FIG. 1, according to another embodiment.

FIG. 9 is a simplified diagram of another example communication system for use in a vehicle such as the vehicle of FIG. 1, according to another embodiment.

FIG. 10 is a simplified diagram of another example communication system for use in a vehicle such as the vehicle of FIG. 1, according to another embodiment.

FIG. 11 is a simplified diagram of another example communication system for use in a vehicle such as the vehicle of FIG. 1, according to another embodiment.

FIG. 12 is a simplified diagram of another example communication system for use in a vehicle such as the vehicle of FIG. 1, according to another embodiment.

FIG. 13 is a simplified diagram of another example communication system for use in a vehicle such as the vehicle of FIG. 1, according to another embodiment.

FIG. 14 is a simplified block diagram of an example communication device that is used in one or more of the communication systems of FIGS. 1-14, in various embodiments.

FIG. 15 is a simplified block diagram of another example communication device that is used in one or more of the communication systems of FIGS. 1-14, in various embodiments.

FIG. 16 is a flow diagram of an example method for manufacturing a vehicle such as the vehicle of FIG. 1, according to an embodiment.

FIG. 17 is a flow diagram of another example method for manufacturing a vehicle such as the vehicle of FIG. 1, according to another embodiment.

### DETAILED DESCRIPTION

Coaxial cables are currently used in some in-vehicle communication applications, and their use in vehicles is increasing. As discussed above, however, in-vehicle communication systems using coaxial cables can be susceptible to ground loop problems. Embodiments of techniques for reducing adverse effects of electromagnetic interference (EMI) in vehicles caused by ground loops are described below.

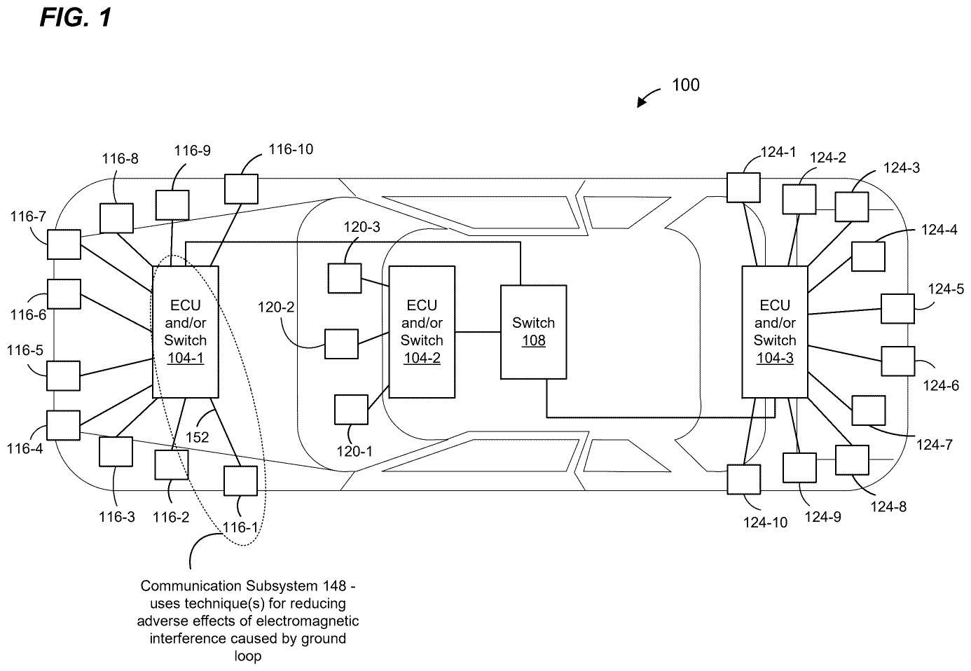

FIG. 1 is a simplified diagram of an example vehicle 100 in which various aspects, features, and elements described herein are implemented in accordance with an embodiment of this disclosure. The vehicle 100 includes a communications network (or simply “network”) that enables communication among different subsystems in the vehicle 100. The network includes a plurality of electronic control units (ECUs) 104 communicatively coupled to a network switch 108. In an embodiment, one or more of the ECUs 104 perform operations corresponding to advanced drive assistance (ADAS) functions. In another embodiment, one or more of the ECUs 104 additionally or alternatively perform operations corresponding to in-vehicle infotainment (IVI) functions. In another embodiment, one or more of the ECUs 104 additionally or alternatively perform operations corresponding to engine control and/or monitoring functions. In other embodiments, one or more of the ECUs 104 additionally or alternatively perform other suitable operations.

Although three ECUs 104 are illustrated in FIG. 1, the vehicle 100 includes other suitable numbers of ECUs in other embodiments, such as one, two, four, five, six, etc.

The network switch 108 is communicatively connected to the ECUs 104 via respective communication links. In various embodiments, the communication links correspond to suitable cables such as cables used with Ethernet 100BASE-T1, Ethernet 1000BASE-T1, IEEE 802.3ch compliant Multi-Gig Automotive Ethernet 2.5GBASE-T1, 5GBASE-T1, 10BASE-TIS, cables that conform to the International Organization for Standardization (ISO) Standard 19642-11, etc. In other embodiments, the communication links correspond to other suitable cables.

Each of the ECUs 104 comprises a respective processor (not shown) that executes machine readable instructions stored in a respective memory device (not shown) of the ECU 104, in an embodiment.

Each of one or more of the ECUs 104 also includes a respective network switch, in some embodiments. In another embodiment, none of the ECUs 104 includes a network switch.

The network switch 108 includes a plurality of network interfaces. In an embodiment, a first network interface of the network switch 108 is communicatively connected to a network interface of the ECU 104-1; a second network interface of the network switch 108 is communicatively connected to a network interface of the ECU 104-2; and a third network interface of the network switch 108 is communicatively connected to a network interface of the ECU 104-3.

A network switch of (or communicatively coupled to) the ECU 104-1 is communicatively connected to vehicle subsystem assemblies 116 via respective communication links. In various embodiments, the communication links correspond to suitable cables such as cables described above.

The vehicle subsystem assemblies 116 includes respective Ethernet interface devices and one or more of: i) one or more sensors, ii) one or more actuators, iii) one or more control modules (e.g., comprising a hardware state machine and/or a processor that executes machine readable instructions stored in a memory device), etc., according to various embodiments.

Similarly, a network switch of (or communicatively coupled to) the ECU 104-2 is communicatively connected to vehicle subsystem assemblies 120 via respective communication links; and the network switch of the ECU 104-3 is communicatively connected to vehicle subsystem assemblies 124 via respective communication links.

The vehicle subsystem assemblies 120 and 124 have structures similar to the vehicle subsystem assemblies 116, in an embodiment, but at least some of the subsystem assemblies 116, 120, and 124 correspond to different functionality of the vehicle 100, in some embodiments. For example, at least some of the subsystem assemblies 116 are associated with advanced drive assistance (ADAS) functions and/or engine control and/or monitoring functions; at least some of the subsystem assemblies 120 are associated with in-vehicle infotainment (IVI) functions; and at least some of the subsystem assemblies 124 are associated with hatch operation and/or parking assistance, according to an embodiment. In other embodiments, one or more of the ECUs 104 additionally or alternatively perform other suitable operations.

Pairs of devices 104, 116, 120, 124 connected by a cable for communication subsystems. The pairs of devices 104, 116, 120, 124 form communication subsystems, and at least some of the communication subsystems respectively utilize one or more techniques for reducing adverse effects of electromagnetic interference caused by ground loops such as described herein, in at least some embodiments.

For example, a communication system 148 comprising the ECU/switch 104-1 and the vehicle subsystem assembly 116-1 utilizes one or more techniques for reducing adverse effects of electromagnetic interference caused by ground loops such as described herein, in an embodiment. The ECU/switch 104-1 and the vehicle subsystem assembly 116-1 are connected via a coaxial cable 152, in an embodiment.

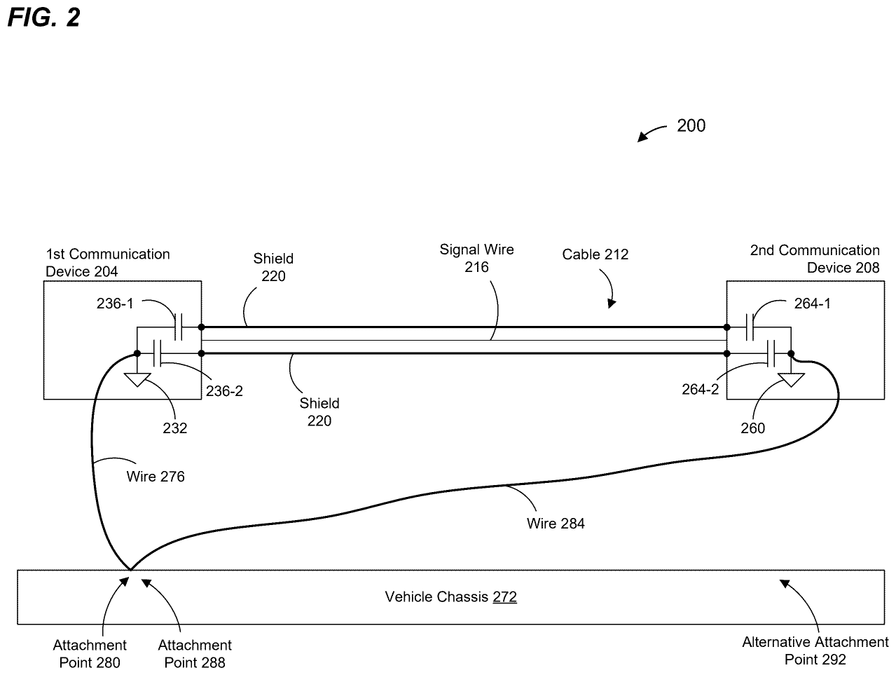

FIG. 2 is a simplified diagram of an example communication system 200 for use in a vehicle, according to an embodiment. The communication system 200 is utilized in the vehicle 100 of FIG. 1, in an embodiment, and FIG. 2 is described with reference to FIG. 1 merely for explanatory purposes. In other embodiments, the communication system 200 is utilized in another suitable vehicle different than the vehicle 100. In other embodiments, the vehicle 100 includes suitable communication systems different than the example communication system 200.

The communication system 200 corresponds to the communication system 148 of FIG. 1, in an embodiment. In other embodiments, one or more other communication systems of the vehicle 100 additionally or alternatively have a structure the same as or similar to the communication system 200.

The communication system 200 includes a first communication device 204 electrically coupled to a second communication device 208 via a coaxial cable 212. The coaxial cable 212 comprises a coaxial cable suitable for use in an in-vehicle communication system, such as a coaxial cable that conforms to the ISO Standard 19642-11, or another suitable coaxial cable. In other embodiments, the cable 212 comprises another suitable shielded cable.

In an embodiment, the first communication device 204 corresponds to the ECU 104-1 or a network switch, such as a network switch of or coupled to the ECU 104-1. In an embodiment, the second communication device 208 corresponds to the vehicle subsystem assembly 116-1, and comprises a sensor module having a camera, a radar, a lidar, etc. In another embodiment, the first communication device 204 corresponds to an ECU 104 and the second communication device 208 corresponds to a network switch, such as the network switch 108. In another embodiment, the first communication device 204 corresponds to the network switch 108 and the second communication device 208 corresponds to another network switch in the vehicle 100.

The coaxial cable 212 comprises a signal wire 216 surrounded by a metallic shield 220.

The first communication device 204 includes a ground plane 232 which includes a relatively large area of metal (e.g., as compared to non-ground signal wires, non-ground signal traces, etc., of circuits of the first communication device 204) configured to act as a return path for circuits of the first communication device 204. In an embodiment, the first communication device 204 includes a printed circuit board (PCB), and the ground plane 232 comprises a metallic (e.g., copper) layer of the PCB that is configured to act as a return path for circuits of the first communication device 204.

The signal wire 216 of the coaxial cable 212 is electrically connected to one or more non-ground signal wires, one or more non-ground signal traces, etc., of one or more circuits of the first communication device 204. The shield 220 of the coaxial cable 212 is electrically coupled to the ground plane 232 via one or more capacitors 236, providing an alternating current (AC) coupling between the shield 220 and the ground plane 232.

The second communication device 208 includes a ground plane 260 which includes a relatively large area of metal (e.g., as compared to non-ground signal wires, non-ground signal traces, etc., of circuits of the second communication device 208) configured to act as a return path for circuits of the second communication device 208. In an embodiment, the second communication device 208 includes a PCB, and the ground plane 260 comprises a metallic (e.g., copper) layer of the PCB that is configured to act as a return path for circuits of the second communication device 208.

The signal wire 216 of the coaxial cable 212 is electrically connected to one or more non-ground signal wires, one or more non-ground signal traces, etc., of one or more circuits of the second communication device 208. The shield 220 of the coaxial cable 212 is electrically coupled to the ground plane 260 via one or more capacitors 264, providing an AC coupling between the shield 220 and the ground plane 260.

The ground plane 232 of the first communication device 204 is electrically connected to a vehicle chassis 272 (e.g., to a vehicle frame of the chassis) via a wire 276. The wire 276 is connected to the chassis 272 at a connection point 280. In an embodiment, the chassis 272 includes (or is connected to) a first connection mechanism (not shown) corresponding to the connection point 280 (or the first connection mechanism is mounted to the chassis 272), where the first connection mechanism is configured to connect to a second connection mechanism attached to the wire 276. In an embodiment, the first connection mechanism comprises a post, a bolt, etc., that is a component of or connected to the chassis 272, and that is configured to connect with a second connection mechanism attached to the wire 276, such as a clamp, a clip, a receptacle, etc. In another embodiment, the first connection mechanism comprises an aperture, a threaded aperture, etc., that is within and/or electrically connected to the chassis 272, and that is configured to connect with a connection mechanism attached to the wire 276, such as a post, a bolt, etc. In other embodiments, the first and second connection mechanisms have other suitable structures.

The ground plane 260 of the second communication device 208 is also electrically connected to the vehicle chassis 272 (e.g., to the vehicle frame of the chassis) via a wire 284. The wire 284 is electrically connected to the chassis 272 at a connection point 288 that is proximate to the connection point 280. The connection point 288 is the same as the connection point 280, in an embodiment. In another embodiment, the connection point 288 is located on the chassis 272 proximate to the connection point 280. In another embodiment, the connection point 288 is located on the wire 276. In an embodiment in which the chassis 272 includes (or is connected to) the first connection mechanism (not shown) described above, the first connection mechanism is configured to connect to a third connection mechanism attached to the wire 284. In another embodiment in which the chassis 272 includes (or is connected to) the first connection mechanism (not shown) described above, the chassis includes or is connected to a fourth connection mechanism that is configured to connect to the third connection mechanism attached to the wire 284, where the fourth connection mechanism is proximate to the first connection mechanism.

In another embodiment, an additional wire (not shown) is connected to the chassis 272, the wire 276 is connected to the additional wire at the connection point 280 (i.e., the connection point 280 is on the additional wire), and the wire 284 is connected to the additional wire at the connection point 288 (i.e., the connection point 288 is on the additional wire), which is proximate to the connection point 280.

In various embodiments, the connection point 288 is within 30 centimeters (cm) of the connection point 280. In various other embodiments, the connection point 288 is within 20 cm of the connection point 280. In various other embodiments, the connection point 288 is within 10 cm of the connection point 280. In various other embodiments, the connection point 288 is within 5 cm of the connection point 280.

Because the connection point 288 is proximate to the connection point 280, an area of a ground loop formed via the shield 220 of the cable 212 and the wires 276, 284 is significantly smaller than a ground loop that would have been formed if the wire 284 were connected to the chassis 272 at an alternative connection point 292 that is closer to the second communication device 208 and significantly further from the connection point 280. In an embodiment, a length of the wire 284 is significantly longer as compared to a length of a wire needed to electrically connect the ground plane 260 to the chassis 272 at the connection point 292 that is more proximate to the second communication device 208 as compared to the connection point 288.

Generally, a level of adverse effects tends to increase as an area of the ground loop increases. Thus, because the area of the ground loop is significantly smaller than the ground loop that would have been formed if the wire 284 were connected to the chassis 272 at the alternative connection point 292, a level of adverse effects caused by the ground loop (e.g., bit errors) is reduced as compared to if the wire 284 were connected to the chassis 272 at the alternative connection point 292, at least in some embodiments. because a level of adverse effects tends to increase as an area of the ground loop increases, at least in some embodiments and/or implementations.

The AC coupling of the shield 220 to the ground plane 232 of the first communication device 204 and the AC coupling of the shield 220 to the ground plane 260 of the second communication device 208 further help to attenuate low frequency EMI and thus may further reduce adverse effects due to EMI, at least in some embodiments.

Although FIG. 2 depicts the attachment points 280,288 being located closer to the first communication device 204 than the second communication device 208, the attachment points 280,288 are located approximately equidistant to the first communication device 204 and the second communication device 208, or are located closer to the second communication device 208 than the first communication device 204, in other embodiments.

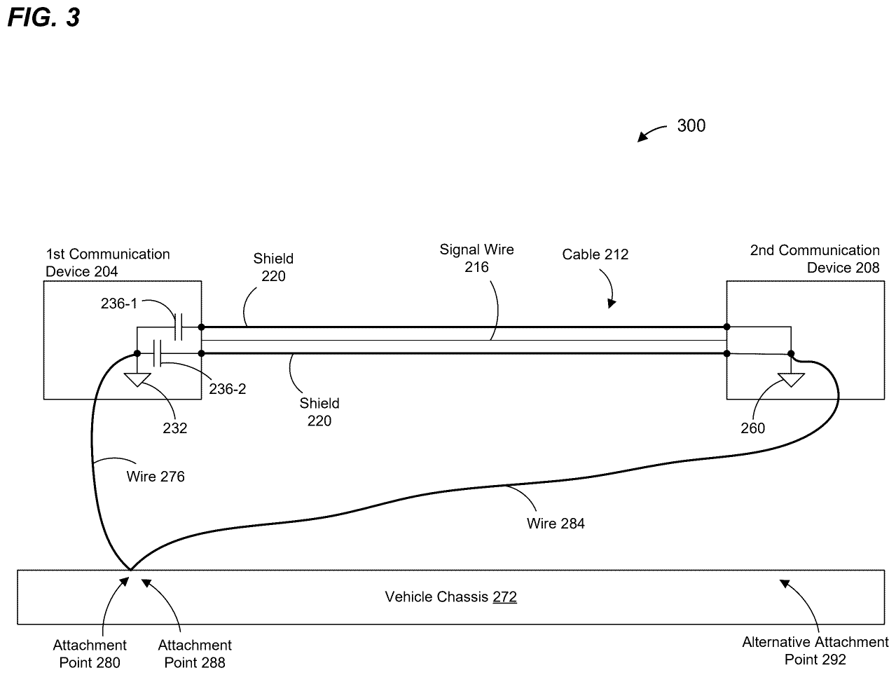

FIG. 3 is a simplified diagram of another example communication system 300 for use in a vehicle, according to another embodiment. The communication system 300 is utilized in the vehicle 100 of FIG. 1, in an embodiment, and FIG. 3 is described with reference to FIG. 1 merely for explanatory purposes. In other embodiments, the communication system 300 is utilized in another suitable vehicle different than the vehicle 100. In other embodiments, the vehicle 100 includes suitable communication systems different than the example communication system 300.

The communication system 300 corresponds to the communication system 148 of FIG. 1, in an embodiment. In other embodiments, one or more other communication systems of the vehicle 100 additionally or alternatively have a structure the same as or similar to the communication system 300.

The communication system 300 is similar to the communication system 200 of FIG. 2, and like-numbered elements are not described again in detail merely for purposes of brevity. Unlike the communication system 200, the second communication device 208 omits the capacitors 264, and the shield 220 of the coaxial cable 212 is electrically connected to the ground plane 260, providing a direct current (DC) coupling between the shield 220 and the ground plane 260. Because the shield 220 is DC coupled to the ground plane 260, the communication system 300 may experience higher levels of adverse effects due to low frequency EMI as compared to the communication system 200 of FIG. 2, at least in some embodiments and/or implementations.

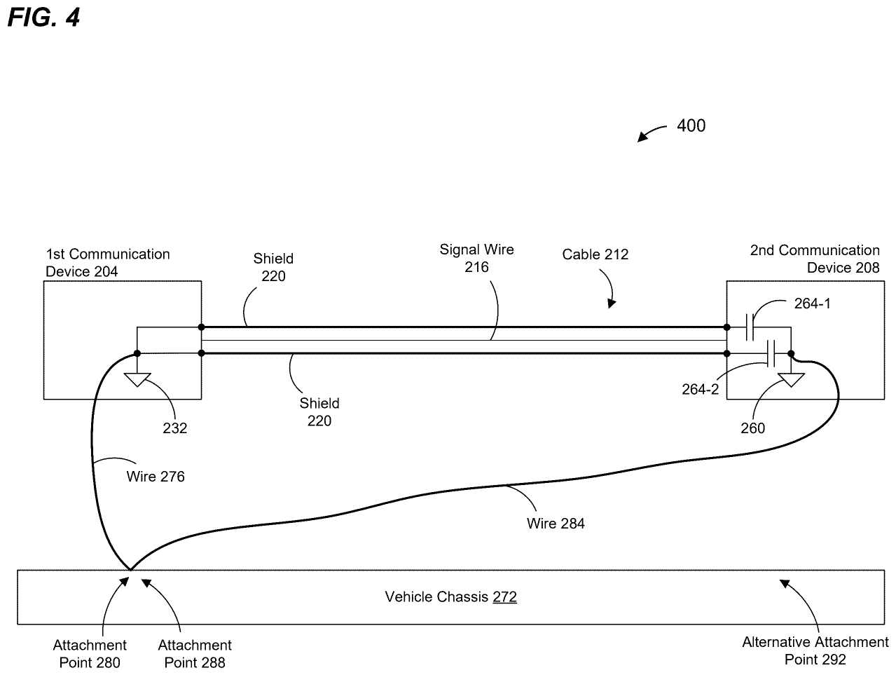

FIG. 4 is a simplified diagram of another example communication system 400 for use in a vehicle, according to another embodiment. The communication system 400 is utilized in the vehicle 100 of FIG. 1, in an embodiment, and FIG. 4 is described with reference to FIG. 1 merely for explanatory purposes. In other embodiments, the communication system 400 is utilized in another suitable vehicle different than the vehicle 100. In other embodiments, the vehicle 100 includes suitable communication systems different than the example communication system 400.

The communication system 400 corresponds to the communication system 148 of FIG. 1, in an embodiment. In other embodiments, one or more other communication systems of the vehicle 100 additionally or alternatively have a structure the same as or similar to the communication system 400.

The communication system 400 is similar to the communication system 200 of FIG. 2, and like-numbered elements are not described again in detail merely for purposes of brevity. Unlike the communication system 200, the first communication device 204 omits the capacitors 236, and the shield 220 of the coaxial cable 212 is electrically connected to the ground plane 232, providing a DC coupling between the shield 220 and the ground plane 232. Because the shield 220 is DC coupled to the ground plane 232, the communication system 400 may experience higher levels of adverse effects due to low frequency EMI as compared to the communication system 200 of FIG. 2, at least in some embodiments and/or implementations.

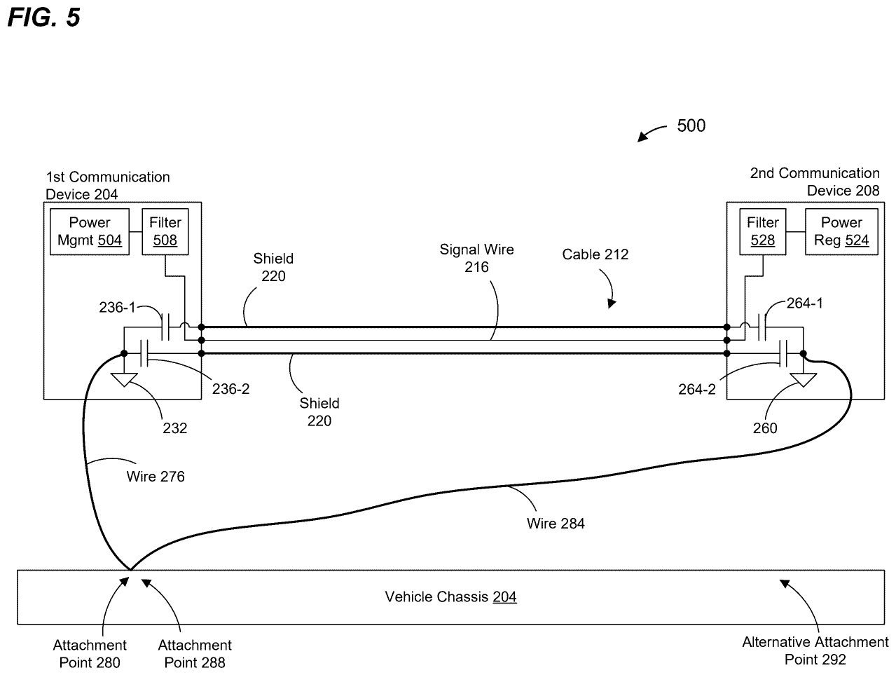

FIG. 5 is a simplified diagram of another example communication system 500 for use in a vehicle, according to another embodiment. The communication system 500 is utilized in the vehicle 100 of FIG. 1, in an embodiment, and FIG. 5 is described with reference to FIG. 1 merely for explanatory purposes. In other embodiments, the communication system 500 is utilized in another suitable vehicle different than the vehicle 100. In other embodiments, the vehicle 100 includes suitable communication systems different than the example communication system 500.

The communication system 500 corresponds to the communication system 148 of FIG. 1, in an embodiment. In other embodiments, one or more other communication systems of the vehicle 100 additionally or alternatively have a structure the same as or similar to the communication system 500.

The communication system 500 is similar to the communication system 200 of FIG. 2, and like-numbered elements are not described again in detail merely for purposes of brevity. The communication system 500 corresponds to a power over cable (PoC) implementation in which the first communication device 204 supplies power to the second communication device 208 via the cable 212.

The first communication device 204 includes power management circuitry 504 electrically coupled to the signal wire 216 of the coaxial cable 212 via filter circuitry 508. The power management circuitry 504 is configured to provide power to the second communication device 208 via the signal wire 216. The filter circuitry 508 is configured to attenuate information signals toward the power management circuitry 504.

The second communication device 208 includes power regulator circuitry 524 electrically coupled to the signal wire 216 of the coaxial cable 212 via filter circuitry 528. The power regulator circuitry 524 is configured to generate a regulated power voltage for the second communication device 208 using the power signal received from the first communication device 204 via the signal wire 216. The filter circuitry 528 is configured to attenuate information signals toward the regulator circuitry 524. A return path to the power management circuitry 504 for circuitry of the second communication device 208 is provided at least by the wire 284 and the wire 276, in an embodiment.

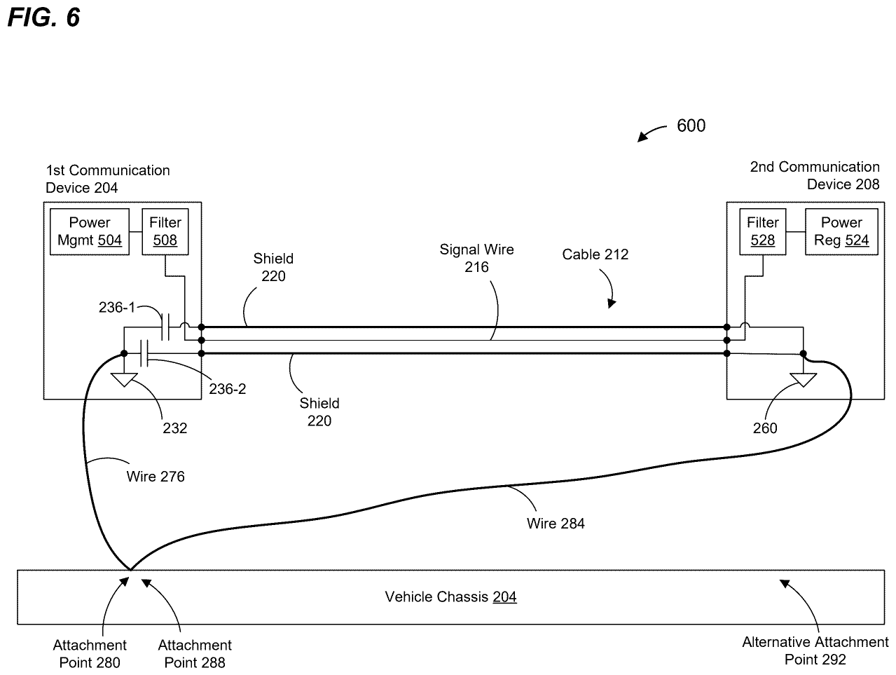

FIG. 6 is a simplified diagram of another example communication system 600 for use in a vehicle, according to another embodiment. The communication system 600 is utilized in the vehicle 100 of FIG. 1, in an embodiment, and FIG. 6 is described with reference to FIG. 1 merely for explanatory purposes. In other embodiments, the communication system 600 is utilized in another suitable vehicle different than the vehicle 100. In other embodiments, the vehicle 100 includes suitable communication systems different than the example communication system 600.

The communication system 600 corresponds to the communication system 148 of FIG. 1, in an embodiment. In other embodiments, one or more other communication systems of the vehicle 100 additionally or alternatively have a structure the same as or similar to the communication system 600.

The communication system 600 is similar to the communication system 500 of FIG. 5, and like-numbered elements are not described again in detail merely for purposes of brevity. Unlike the communication system 500, the second communication device 208 omits the capacitors 264, and the shield 220 of the coaxial cable 212 is electrically connected to the ground plane 260, providing a DC coupling between the shield 220 and the ground plane 260. Because the shield 220 is DC coupled to the ground plane 260, the communication system 600 may experience higher levels of adverse effects due to low frequency EMI as compared to the communication system 500 of FIG. 5, at least in some embodiments and/or implementations.

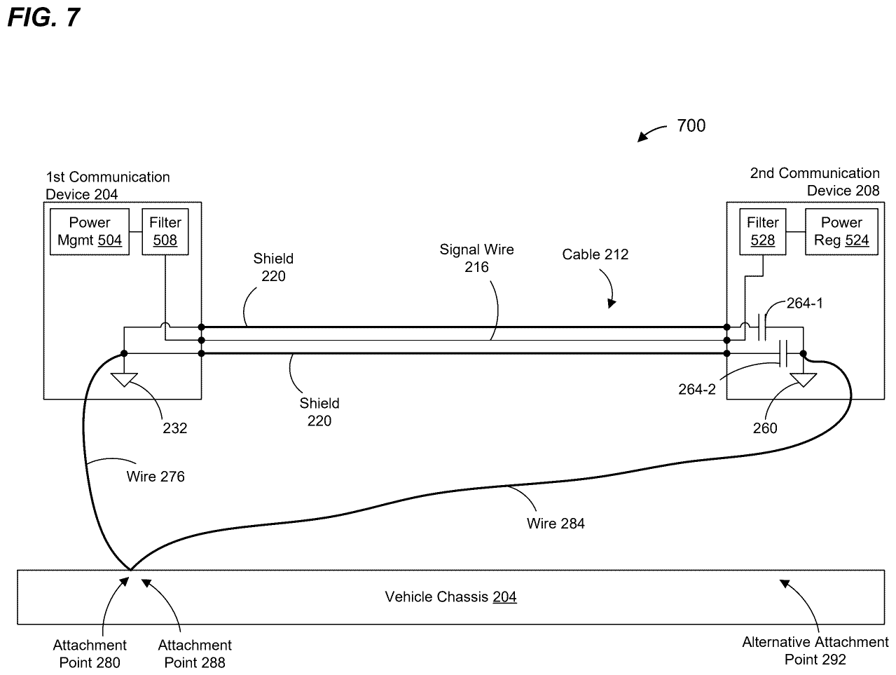

FIG. 7 is a simplified diagram of another example communication system 700 for use in a vehicle, according to another embodiment. The communication system 700 is utilized in the vehicle 100 of FIG. 1, in an embodiment, and FIG. 7 is described with reference to FIG. 1 merely for explanatory purposes. In other embodiments, the communication system 700 is utilized in another suitable vehicle different than the vehicle 100. In other embodiments, the vehicle 100 includes suitable communication systems different than the example communication system 700.

The communication system 700 corresponds to the communication system 148 of FIG. 1, in an embodiment. In other embodiments, one or more other communication systems of the vehicle 100 additionally or alternatively have a structure the same as or similar to the communication system 700.

The communication system 700 is similar to the communication system 500 of FIG. 5, and like-numbered elements are not described again in detail merely for purposes of brevity. Unlike the communication system 500, the first communication device 204 omits the capacitors 236, and the shield 220 of the coaxial cable 212 is electrically connected to the ground plane 232, providing a DC coupling between the shield 220 and the ground plane 232. Because the shield 220 is DC coupled to the ground plane 232, the communication system 700 may experience higher levels of adverse effects due to low frequency EMI as compared to the communication system 500 of FIG. 5, at least in some embodiments and/or implementations.

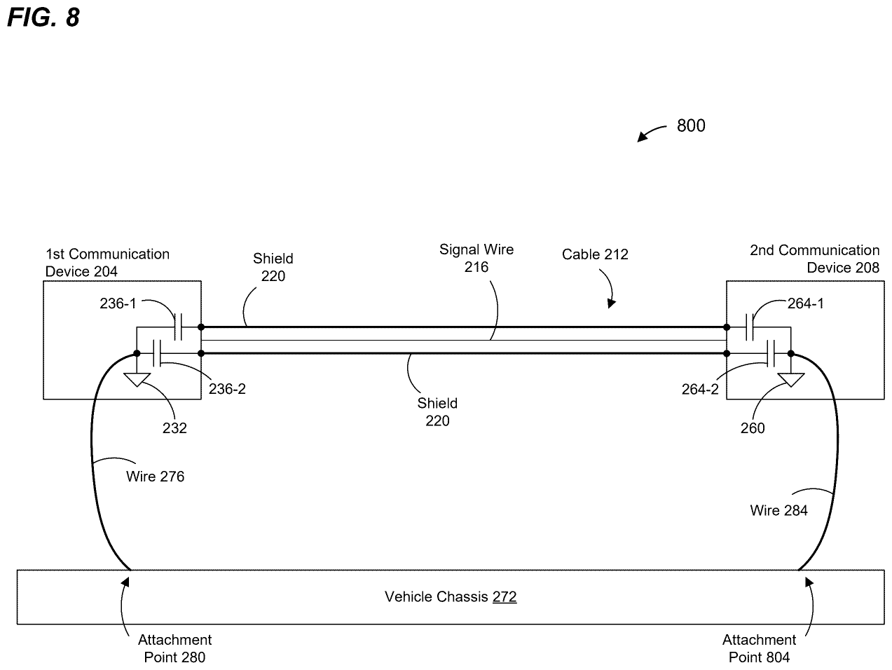

FIG. 8 is a simplified diagram of another example communication system 800 for use in a vehicle, according to another embodiment. The communication system 800 is utilized in the vehicle 100 of FIG. 1, in an embodiment, and FIG. 8 is described with reference to FIG. 1 merely for explanatory purposes. In other embodiments, the communication system 800 is utilized in another suitable vehicle different than the vehicle 100. In other embodiments, the vehicle 100 includes suitable communication systems different than the example communication system 800.

The communication system 800 corresponds to the communication system 148 of FIG. 1, in an embodiment. In other embodiments, one or more other communication systems of the vehicle 100 additionally or alternatively have a structure the same as or similar to the communication system 800.

The communication system 800 is similar to the communication system 200 of FIG. 2, and like-numbered elements are not described again in detail merely for purposes of brevity. Unlike the communication system 200, the wire 284, which couples the ground plane 260 of the second communication device 208 to the vehicle chassis 272, is not electrically connected to the chassis 272 at the connection point 288 (FIG. 2) that is proximate to the connection point 280. Rather, the wire 284 is electrically connected to the chassis 272 at a connection point 804 that is not proximate to the connection point 280, i.e., the connection point 804 is significantly further away from the connection point 280 as compared to the connection point 288. In an embodiment, the connection point 804 is more proximate to the second communication device 208 as compared to the connection point 288.

Because the connection point 804 is not proximate to the connection point 280, an area of a ground loop formed via the shield 220 of the cable 212 and the wires 276, 284 is significantly larger than the ground loop that would have been formed if the wire 284 were connected to the chassis 272 at the connection point 288 (FIG. 2). In an embodiment, the length of the wire 284 is significantly shorter as compared to the length of a wire needed to electrically connect the ground plane 260 to the chassis 272 at the connection point 288.

Because the area of the ground loop formed via the shield 220 of the cable 212 and the wires 276, 284 is significantly larger than the ground loop that would have been formed if the wire 284 were connected to the chassis 272 at the connection point 288, the communication system 800 may experience higher levels of adverse effects due to low frequency EMI as compared to the communication system 200 of FIG. 2, at least in some embodiments and/or implementations.

In an embodiment, the AC coupling of the shield 220 to the ground plane 232 of the first communication device 204 and the AC coupling of the shield 220 to the ground plane 260 of the second communication device 208 help to reduce levels of adverse effects due to low frequency EMI, at least in some embodiments and/or implementations.

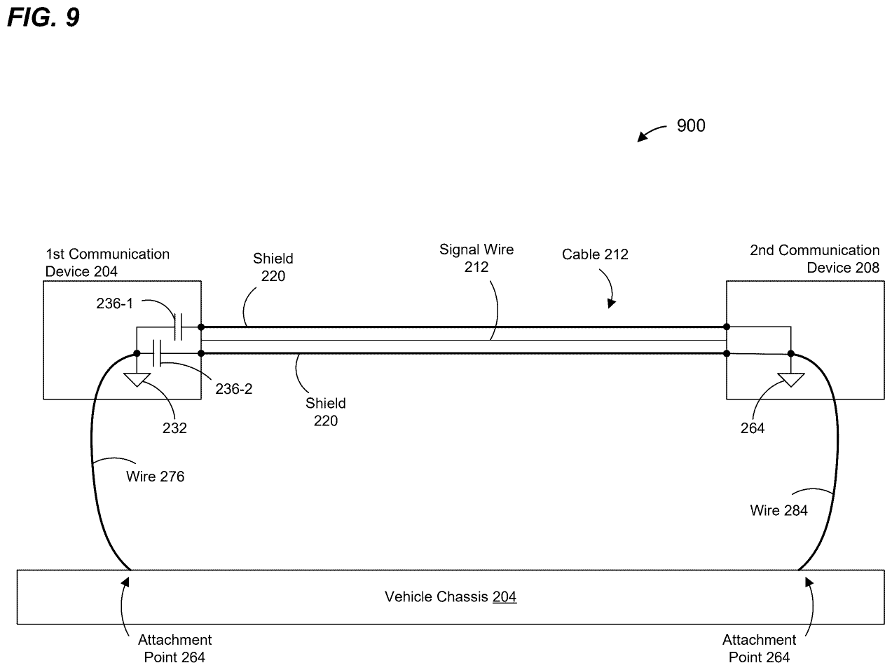

FIG. 9 is a simplified diagram of another example communication system 900 for use in a vehicle, according to another embodiment. The communication system 900 is utilized in the vehicle 100 of FIG. 1, in an embodiment, and FIG. 9 is described with reference to FIG. 1 merely for explanatory purposes. In other embodiments, the communication system 900 is utilized in another suitable vehicle different than the vehicle 100. In other embodiments, the vehicle 100 includes suitable communication systems different than the example communication system 900.

The communication system 900 corresponds to the communication system 148 of FIG. 1, in an embodiment. In other embodiments, one or more other communication systems of the vehicle 100 additionally or alternatively have a structure the same as or similar to the communication system 900.

The communication system 900 is similar to the communication system 800 of FIG. 8, and like-numbered elements are not described again in detail merely for purposes of brevity. Unlike the communication system 800, the second communication device 208 omits the capacitors 264, and the shield 220 of the coaxial cable 212 is electrically connected to the ground plane 260, providing a DC coupling between the shield 220 and the ground plane 260. Because the shield 220 is DC coupled to the ground plane 260, the communication system 1000 may experience higher levels of adverse effects due to low frequency EMI as compared to the communication system 800 of FIG. 8, at least in some embodiments and/or implementations.

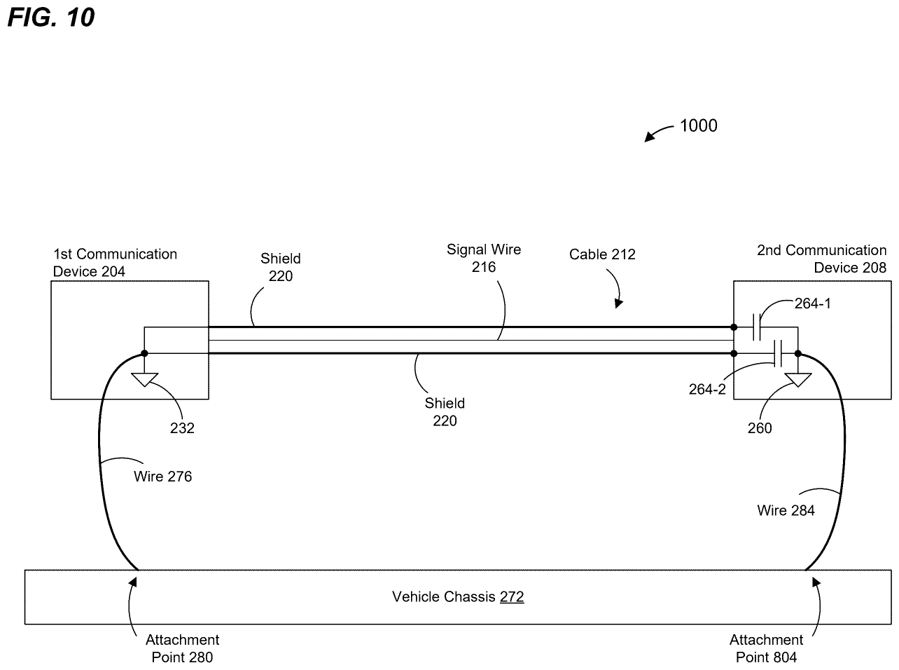

FIG. 10 is a simplified diagram of another example communication system 1000 for use in a vehicle, according to another embodiment. The communication system 1000 is utilized in the vehicle 100 of FIG. 1, in an embodiment, and FIG. 10 is described with reference to FIG. 1 merely for explanatory purposes. In other embodiments, the communication system 1000 is utilized in another suitable vehicle different than the vehicle 100. In other embodiments, the vehicle 100 includes suitable communication systems different than the example communication system 1000.

The communication system 1000 corresponds to the communication system 148 of FIG. 1, in an embodiment. In other embodiments, one or more other communication systems of the vehicle 100 additionally or alternatively have a structure the same as or similar to the communication system 1000.

The communication system 1000 is similar to the communication system 800 of FIG. 8, and like-numbered elements are not described again in detail merely for purposes of brevity. Unlike the communication system 800, the first communication device 204 omits the capacitors 236, and the shield 220 of the coaxial cable 212 is electrically connected to the ground plane 232, providing a DC coupling between the shield 220 and the ground plane 232. Because the shield 220 is DC coupled to the ground plane 232, the communication system 900 may experience higher levels of adverse effects due to low frequency EMI as compared to the communication system 800 of FIG. 8, at least in some embodiments and/or implementations.

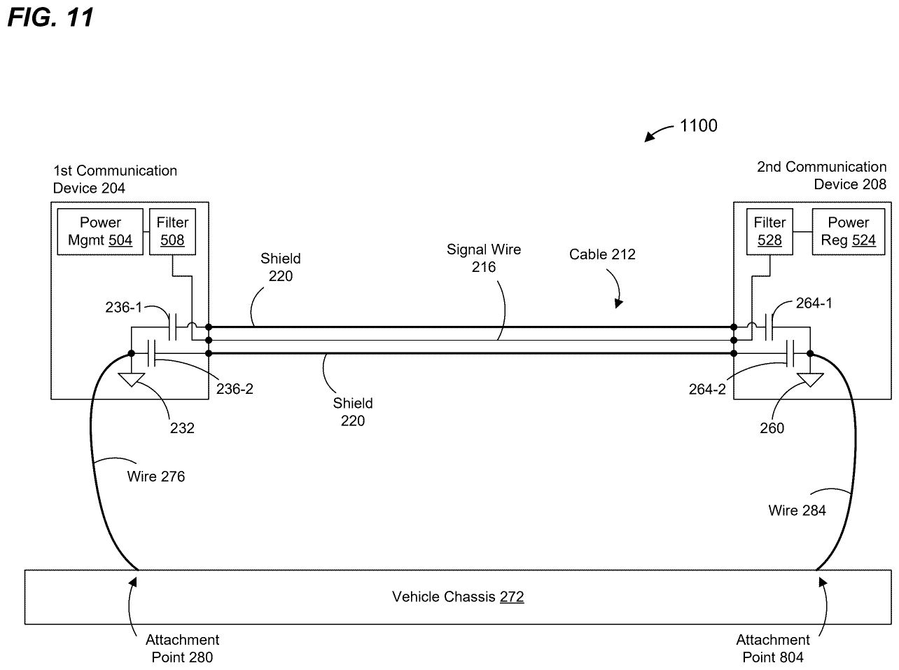

FIG. 11 is a simplified diagram of another example communication system 1100 for use in a vehicle, according to another embodiment. The communication system 1100 is utilized in the vehicle 100 of FIG. 1, in an embodiment, and FIG. 11 is described with reference to FIG. 1 merely for explanatory purposes. In other embodiments, the communication system 1100 is utilized in another suitable vehicle different than the vehicle 100. In other embodiments, the vehicle 100 includes suitable communication systems different than the example communication system 1100.

The communication system 1100 corresponds to the communication system 148 of FIG. 1, in an embodiment. In other embodiments, one or more other communication systems of the vehicle 100 additionally or alternatively have a structure the same as or similar to the communication system 1100.

The communication system 800 is similar to the communication system 500 of FIG. 5, and like-numbered elements are not described again in detail merely for purposes of brevity. Unlike the communication system 500, the wire 284, which couples the ground plane 260 of the second communication device 208 to the vehicle chassis 272, is not electrically connected to the chassis 272 at the connection point 288 (FIG. 5) that is proximate to the connection point 280. Rather, the wire 284 is electrically connected to the chassis 272 at the connection point 804 that is not proximate to the connection point 280, i.e., the connection point 804 is significantly further away from the connection point 280 as compared to the connection point 288.

Because the connection point 804 is not proximate to the connection point 280, an area of a ground loop formed via the shield 220 of the cable 212 and the wires 276, 284 is significantly larger than the ground loop that would have been formed if the wire 284 were connected to the chassis 272 at the connection point 288 (FIG. 5). In an embodiment, the length of the wire 284 is significantly shorter as compared to the length of a wire needed to electrically connect the ground plane 260 to the chassis 272 at the connection point 288.

Because the area of the ground loop formed via the shield 220 of the cable 212 and the wires 276, 284 is significantly larger than the ground loop that would have been formed if the wire 284 were connected to the chassis 272 at the connection point 288, the communication system 1100 may experience higher levels of adverse effects due to low frequency EMI as compared to the communication system 500 of FIG. 5, at least in some embodiments and/or implementations.

In an embodiment, the AC coupling of the shield 220 to the ground plane 232 of the first communication device 204 and the AC coupling of the shield 220 to the ground plane 260 of the second communication device 208 help to reduce levels of adverse effects due to low frequency EMI, at least in some embodiments and/or implementations.

As with the communication system 500 of FIG. 5, a return path to the power management circuitry 504 for circuitry of the second communication device 208 is provided at least by the wire 284 and the wire 276, in an embodiment.

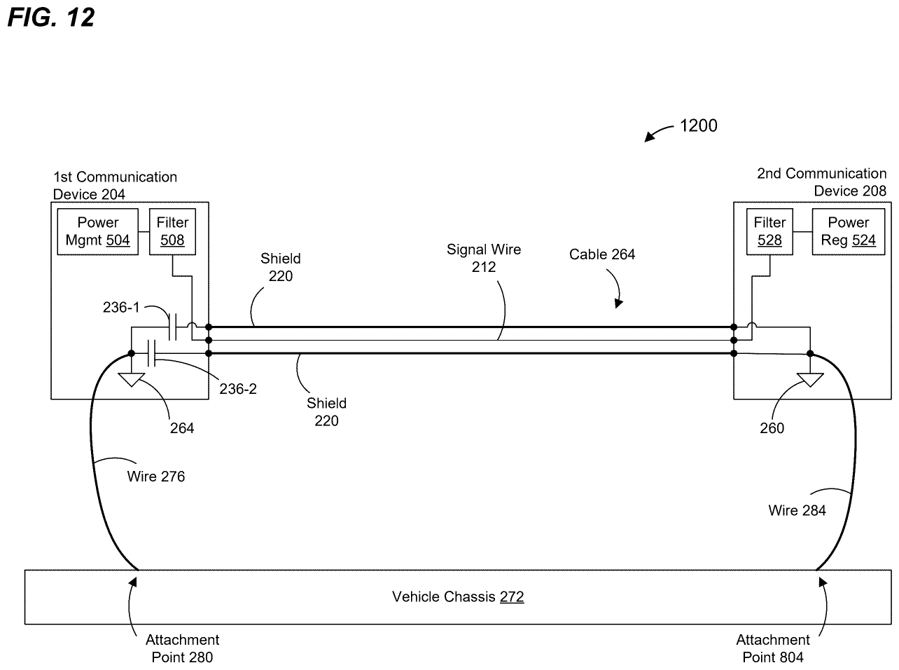

FIG. 12 is a simplified diagram of another example communication system 1200 for use in a vehicle, according to another embodiment. The communication system 1200 is utilized in the vehicle 100 of FIG. 1, in an embodiment, and FIG. 12 is described with reference to FIG. 1 merely for explanatory purposes. In other embodiments, the communication system 1200 is utilized in another suitable vehicle different than the vehicle 100. In other embodiments, the vehicle 100 includes suitable communication systems different than the example communication system 1200.

The communication system 1200 corresponds to the communication system 148 of FIG. 1, in an embodiment. In other embodiments, one or more other communication systems of the vehicle 100 additionally or alternatively have a structure the same as or similar to the communication system 1200.

The communication system 1200 is similar to the communication system 1100 of FIG. 11, and like-numbered elements are not described again in detail merely for purposes of brevity. Unlike the communication system 1100, the second communication device 208 omits the capacitors 264, and the shield 220 of the coaxial cable 212 is electrically connected to the ground plane 260, providing a DC coupling between the shield 220 and the ground plane 260. Because the shield 220 is DC coupled to the ground plane 260, the communication system 900 may experience higher levels of adverse effects due to low frequency EMI as compared to the communication system 800 of FIG. 8, at least in some embodiments and/or implementations.

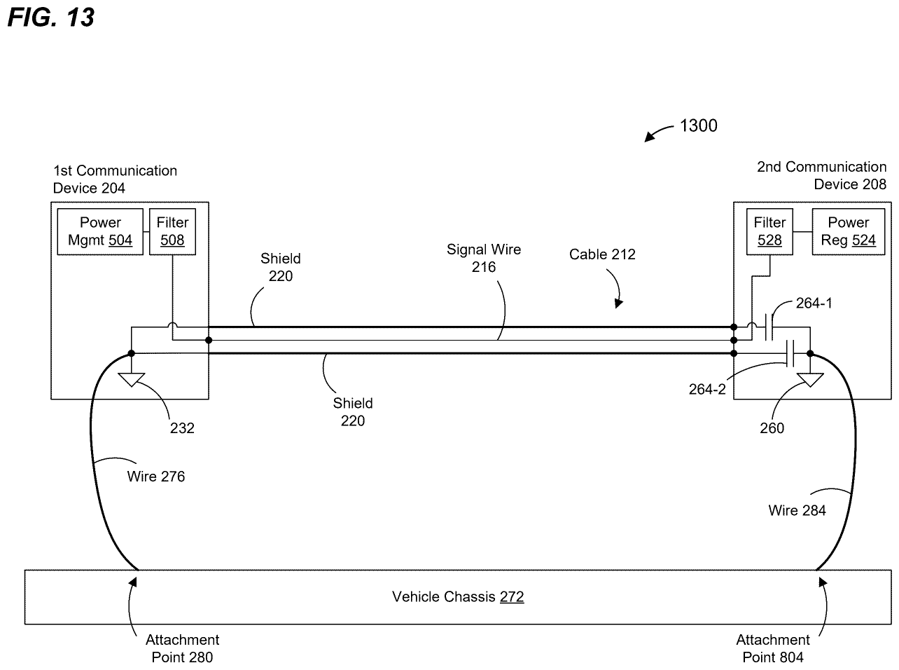

FIG. 13 is a simplified diagram of another example communication system 1300 for use in a vehicle, according to another embodiment. The communication system 1300 is utilized in the vehicle 100 of FIG. 1, in an embodiment, and FIG. 13 is described with reference to FIG. 1 merely for explanatory purposes. In other embodiments, the communication system 1300 is utilized in another suitable vehicle different than the vehicle 100. In other embodiments, the vehicle 100 includes suitable communication systems different than the example communication system 1300.

The communication system 1300 corresponds to the communication system 148 of FIG. 1, in an embodiment. In other embodiments, one or more other communication systems of the vehicle 100 additionally or alternatively have a structure the same as or similar to the communication system 1300.

The communication system 1300 is similar to the communication system 1100 of FIG. 11, and like-numbered elements are not described again in detail merely for purposes of brevity. Unlike the communication system 1100, the first communication device 204 omits the capacitors 236, and the shield 220 of the coaxial cable 212 is electrically connected to the ground plane 232, providing a DC coupling between the shield 220 and the ground plane 232. Because the shield 220 is DC coupled to the ground plane 232, the communication system 1300 may experience higher levels of adverse effects due to low frequency EMI as compared to the communication system 1100 of FIG. 11, at least in some embodiments and/or implementations.

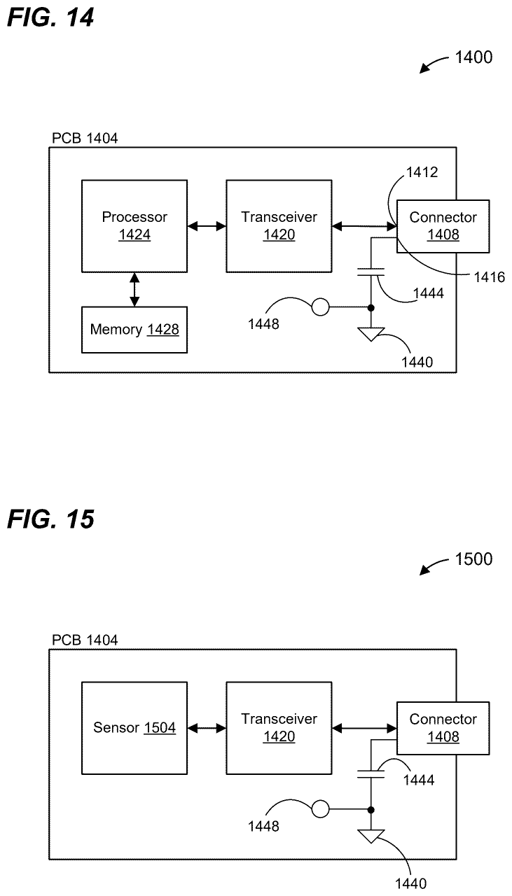

FIG. 14 is a simplified block diagram of an example communication device 1400 that is used in one or more of the communication systems described herein, in various embodiments. The communication device 1400 corresponds to the first communication device 204 of FIGS. 2-13, in some embodiments. The communication device 1400 corresponds to the second communication device 208 of FIGS. 2-13, in other embodiments. In other embodiments, the first communication device 204 and/or the second communication device 208 of FIGS. 2-13 have a suitable structure different than the communication device 1400. In some embodiments, the communication device 1400 is utilized in a suitable communication system different than the communication systems of FIGS. 2-13.

The communication device 1400 includes a printed circuit board (PCB) 1404 and a cable connector 1408 mounted on, or electronically coupled to the PCB 1404. The cable connector 1408 is configured to connect to a shielded cable such as a coaxial cable. The connector 1408 includes a first node 1412 that is electrically coupled to a signal wire of the cable when the cable is connected to the connector 1408. The connector 1408 also includes a second node 1416 that is electrically coupled to a shield of the cable when the cable is connected to the connector 1408.

A transceiver 1420 is mounted on the PCB 1404 and is coupled to the first node 1412. A processor 1424 is mounted on the PCB 1404 and also is coupled to the transceiver 1420. In an embodiment, the processor 1424 is configured to execute machine readable instructions stored in a memory 1428, which is coupled to the processor 1424.

In an embodiment, the communication device 1400 corresponds to an ECU, and the memory 1428 stores machine readable instructions that, when executed by the processor 1424, cause the processor 1424 to perform operations corresponding to functionality of the ECU.

In another embodiment, the communication device 1400 corresponds to a network switch. In some embodiments in which the communication device 1400 corresponds to a network switch, the processor 1424 is a processor configured to process headers of packets received via a plurality of transceivers (including the transceiver 1420) communicatively connected to the processor 1424 to determine transceivers via which the packets are to be forwarded; and the memory 1428 stores packet data of packets being processed by the packet processor 1424.

The transceiver 1420 is configured to i) a) receive transmit data from the processor 1424, b) generate a transmit signal based on the transmit data, and c) provide the transmit signal to the node 1412 of the connector 1408 for transmission via the cable, and ii) a) receive a receive signal from the node 1412 of the connector 1408 (the receive signal having been received via the cable), b) decode receive data from the receive signal, and c) provide the receive data to the processor 1424, in an embodiment.

The PCB 1404 includes a ground plane 1440. In various embodiments, components of one or more of the transceiver 1420, the processor 1424, and the memory 1428 are electrically coupled to the ground plane 1440. Additionally, the node 1416 of the connector 1408 is electrically coupled to the ground plane 1440 via one or more capacitors 1444. In other embodiments, the one or more capacitors 1444 are omitted and the node 1416 is DC coupled to the ground plane 1440.

The PCB 1404 also includes a connection mechanism 1448 that is electrically connected to the ground plane 1440. The connection mechanism 1448 is configured to connect to a connection mechanism attached to a wire that is configured to electrically connect to a vehicle chassis. For example, the connection mechanism 1448 is configured to connect to a connection mechanism attached to the wire 276 or the wire 284, in some embodiments. In an embodiment, the connection mechanism 1448 comprises a post, a bolt, etc., that is electrically connected to the ground plane 1440, and that is configured to connect with a connection mechanism attached to the wire, such as a clamp, a clip, a receptacle, etc. In another embodiment, the connection mechanism 1448 comprises an aperture, a threaded aperture, etc., that is electrically connected to the ground plane 1440, and that is configured to connect with a connection mechanism attached to the wire, such as a post, a bolt, etc. In other embodiments, the connection mechanism 1448 has another suitable structure.

FIG. 15 is a simplified block diagram of another example communication device 1500 that is used in one or more of the communication systems described herein, in various embodiments. The communication device 1500 corresponds to the first communication device 204 of FIGS. 2-13, in some embodiments. The communication device 1500 corresponds to the second communication device 208 of FIGS. 2-13, in other embodiments. In other embodiments, the first communication device 204 and/or the second communication device 208 of FIGS. 2-13 have a suitable structure different than the communication device 1500. In some embodiments, the communication device 1500 is utilized in a suitable communication system different than the communication systems of FIGS. 2-13.

The communication device 1500 is similar to the communication device 1400 of FIG. 14 and like-numbered elements are not described again in detail for purposes of brevity.

The communication device 1500 includes a sensor 1504 mounted on the PCB 1404. The sensor 1504 is coupled to the transceiver 1420. The sensor 1504 comprises a camera, a lidar sensor, a radar sensor, etc., in various embodiments. The sensor 1504 comprises another suitable sensor in other embodiments.

The transceiver 1420 is configured to i) a) receive sensor data from the sensor 1504, b) generate a transmit signal based on the sensor data, and c) provide the transmit signal to the node 1412 of the connector 1408 for transmission via the cable, and ii) a) receive a receive signal from the node 1412 of the connector 1408 (the receive signal having been received via the cable), b) decode control data and/or configuration data from the receive signal, and c) provide the control data and/or configuration data to the sensor 1504, in an embodiment.

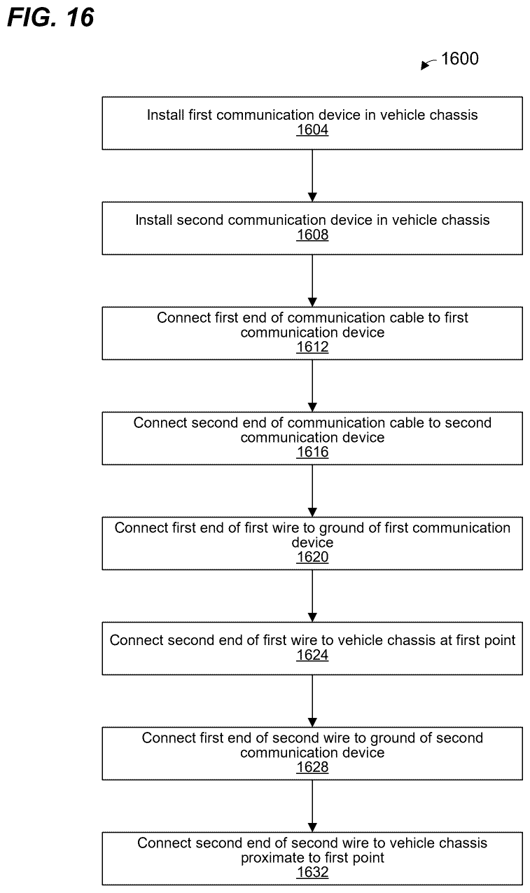

FIG. 16 is a flow diagram of an example method 1600 of manufacturing a vehicle, according to an embodiment. The method 1600 is performed in connection with manufacturing the vehicle 100 of FIG. 1, in some embodiments. The method 1600 is performed in connection with manufacturing a suitable vehicle that is different than the vehicle 100 of FIG. 1, in other embodiments. In various embodiments, the method 1600 includes installing, in a vehicle, a communication system such as the example communication systems described above with reference to FIGS. 2-7, and FIG. 16 is described with reference to FIGS. 2-7 merely for explanatory purposes. In other embodiments, the method 1600 includes installing, in a vehicle, a suitable communication system that is different than the communication systems described above with reference to FIGS. 2-7.

At block 1604, a first communication device is installed in a vehicle chassis. For example, the first communication device 204 is installed in the vehicle chassis 272. As another example, the second communication device 208 is installed in the vehicle chassis 272.

At block 1608, a second communication device is installed in the vehicle chassis. For example, the second communication device 208 is installed in the vehicle chassis 272. As another example, the first communication device 204 is installed in the vehicle chassis 272.

At block 1612, a first end of a shielded cable is connected to the first communication device. In an embodiment, the first communication is configured to, when the shielded cable is connected to the first communication device, electrically couple a shield of the shielded cable to a ground of the first communication device. For example, a first end of the cable 212 is connected to a connector of the first communication device 204.

At block 1616, a second end of a shielded cable is connected to the second communication device. In an embodiment, the second communication is configured to, when the shielded cable is connected to the second communication device, electrically couple a shield of the shielded cable to a ground of the second communication device. For example, a second end of the cable 212 is connected to a connector of the second communication device 208.

At block 1620, a first end of a first wire is connected to the ground of the first communication device. For example, a first end of the wire 276 is connected to the ground 232 of the first communication device 204.

At block 1624, a second end of the first wire is connected to the vehicle chassis at a first point. For example, a second end of the wire 276 is connected to the chassis 272 at the point 280.

At block 1628, a first end of a second wire is connected to the ground of the second communication device. For example, a first end of the wire 284 is connected to the ground 260 of the second communication device 208.

At block 1632, a second end of the second wire is connected to the vehicle chassis proximate to the first point. For example, a second end of the wire 284 is connected to the chassis 272 proximate to the point 280.

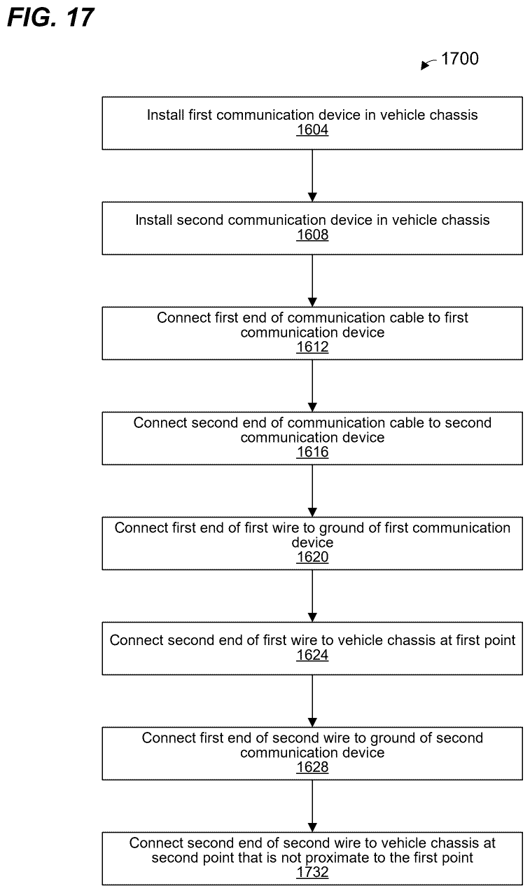

FIG. 17 is a flow diagram of another example method 1700 of manufacturing a vehicle, according to an embodiment. The method 1700 is performed in connection with manufacturing the vehicle 100 of FIG. 1, in some embodiments. The method 1700 is performed in connection with manufacturing a suitable vehicle that is different than the vehicle 100 of FIG. 1, in other embodiments. In various embodiments, the method 1700 includes installing, in a vehicle, a communication system such as the example communication systems described above with reference to FIGS. 8-13, and FIG. 17 is described with reference to FIGS. 8-13 merely for explanatory purposes. In other embodiments, the method 1700 includes installing, in a vehicle, a suitable communication system that is different than the communication systems described above with reference to FIGS. 8-13.

The method 1700 is similar to the method 1600 and like-numbered elements are not described again in detail for purpose of brevity.

Regarding the first communication device installed at block 1604 and the second communication device installed at block 1608, at least one of: i) the first communication device (block 1604) is configured to, when the shielded cable is connected to the first communication device, electrically couple the shield of the shielded cable to the ground of the first communication device via one or more first capacitors; and ii) the second communication device (block 1608) is configured to, when the shielded cable is connected to the second communication device, electrically couple the shield of the shielded cable to the ground of the second communication device via one or more second capacitors.

At block 1732, a second end of the second wire is connected to the vehicle chassis at a second point that is not proximate to the first point. For example, a second end of the wire 284 is connected to the chassis 272 at the point 804.

Some of the various blocks, operations, and techniques described above may be implemented utilizing hardware, a processor executing firmware instructions, a processor executing software instructions, or any suitable combination thereof. When implemented utilizing a processor executing software or firmware instructions, the software or firmware instructions may be stored in any suitable computer readable memory. The software or firmware instructions may include machine readable instructions that, when executed by one or more processors, cause the one or more processors to perform various acts such as described above.

When implemented in hardware, the hardware may comprise one or more of discrete components, an integrated circuit, an application-specific integrated circuit (ASIC), a programmable logic device (PLD), etc.

While the present invention has been described with reference to specific examples, which are intended to be illustrative only and not to be limiting of the invention, changes, additions and/or deletions may be made to the disclosed embodiments without departing from the scope of the invention.

What is claimed is:

1. A communication system for use in a vehicle, comprising:
a first communication device configured for operation in the vehicle, the first communication device having a first ground;
a second communication device configured for operation in the vehicle, the second communication device having a second ground;
a shielded cable that communicatively connects the first communication device and the second communication device, the shielded cable having i) a signal wire that is electrically connected to the first communication device and the second communication device, and ii) a shield that is electrically coupled to the first ground and the second ground;
a first wire having i) a first end electrically connected to the first ground and ii) a second end electrically connected to a chassis of the vehicle at a first point; and
a second wire having i) a first end electrically connected to the second ground and ii) a second end electrically connected to the chassis proximate to the first point to mitigate effects of electromagnetic interference (EMI) on the communication system.

2. The communication system of claim 1, wherein:
the first communication device is configured to couple the shield of the cable to the first ground via one or more first capacitors to further mitigate effects of the EMI on the communication system.

3. The communication system of claim 2, wherein:
the second communication device is configured to couple the shield of the cable to the second ground via one or more second capacitors to further mitigate effects of the EMI on the communication system.

4. The communication system of claim 2, wherein:
the first communication device comprises power management circuitry that is configured to provide power to the second communication device via the signal wire; and
the second communication device comprises power regulator circuitry that is configured to generate a regulated power voltage for the second communication device using the power received from the first communication device via the signal wire.

5. The communication system of claim 4, wherein:
the second communication device is configured to couple the shield of the cable to the second ground via one or more second capacitors to further mitigate effects of the EMI on the communication system.

6. The communication system of claim 1, wherein:
the first communication device comprises power management circuitry that is configured to provide power to the second communication device via the signal wire;
the second communication device comprises power regulator circuitry that is configured to generate a regulated power voltage for the second communication device using the power received from the first communication device via the signal wire; and
the second communication device is configured to couple the shield of the cable to the second ground via one or more second capacitors to further mitigate effects of the EMI on the communication system.

7. The communication system of claim 1, wherein the second end of the first wire is connected to the chassis of the vehicle at the first point.

8. The communication system of claim 7, wherein the second end of the second wire is connected to the chassis of the vehicle proximate to the first point.

9. The communication system of claim 7, wherein the second end of the second wire is connected to the first wire.

10. The communication system of claim 1, wherein the second end of the second wire is connected to the chassis of the vehicle.

11. The communication system of claim 10, wherein the second end of the first wire is connected to the second wire.

12. A method for manufacturing a vehicle, comprising:
installing a first communication device in a chassis of the vehicle, the first communication device having a first ground;
installing a second communication device in the chassis, the second communication device having a second ground;
connecting a first end of a shielded cable to the first communication device, the first communication device being configured to electrically couple a shield of the shielded cable to the first ground when the shielded cable is connected to the first communication device;
connecting a second end of the shielded cable to the second communication device, the second communication device being configured to electrically couple the shield of the shielded cable to the second ground when the shielded cable is connected to the second communication device;
electrically connecting a first end of a first wire to the first ground of the first communication device;
electrically connecting a second end of the first wire to the chassis at a first point;
electrically connecting a first end of a second wire to the second ground of the second communication device; and
electrically connecting a second end of the second wire to the chassis proximate to the first point to mitigate effects of electromagnetic interference (EMI) on the communication system.

13. The method for manufacturing the vehicle of claim 1, wherein electrically connecting the second end of the first wire to the chassis comprises connecting the second end of the first wire to the chassis at the first point.

14. The method for manufacturing the vehicle of claim 13, wherein electrically connecting the second end of the second wire to the chassis comprises connecting the second end of the second wire to the chassis proximate to the first point.

15. A communication system for use in a vehicle, comprising:
a first communication device configured for operation in the vehicle, the first communication device having a first ground;
a second communication device configured for operation in the vehicle, the second communication device having a second ground;
a shielded cable that communicatively connects the first communication device and the second communication device, the shielded cable having i) a signal wire that is electrically connected to the first communication device and the second communication device, and ii) a shield that is electrically coupled to the first ground and the second ground, wherein the first communication device is configured to couple the shield of the cable to the first ground via one or more first capacitors to mitigate effects of electromagnetic interference (EMI) on the communication system;
a first wire having i) a first end electrically connected to the first ground and ii) a second end electrically connected to a chassis of the vehicle at a first point; and
a second wire having i) a first end electrically connected to the second ground and ii) a second end electrically connected to the chassis proximate a second point different than the first point.

16. The communication system of claim 15, wherein:
the first communication device comprises power management circuitry that is configured to provide power to the second communication device via the signal wire; and
the second communication device comprises power regulator circuitry that is configured to generate a regulated power voltage for the second communication device using the power received from the first communication device via the signal wire.

17. The communication system of claim 16, wherein the second communication device is configured to provide a return path for circuitry of the second communication device via the second wire.

18. The communication system of claim 15, wherein:
the second communication device is configured to couple the shield of the cable to the second ground via one or more second capacitors to further mitigate effects of the EMI on the communication system.

19. The communication system of claim 18, wherein:
the first communication device comprises power management circuitry that is configured to provide power to the second communication device via the signal wire; and
the second communication device comprises power regulator circuitry that is configured to generate a regulated power voltage for the second communication device using the power received from the first communication device via the signal wire.

20. The communication system of claim 18, wherein the second point is not proximate to the first point.
